(19) United States
(12) Patent Application Publication
(10) Pub. No.: US 2023/0109373 A1
(43) Pub. Date: Apr. 6, 2023

(54) LITHIUM SECONDARY BATTERY

(71) Applicant: Samsung SDI Co., Ltd., Yongin-si, Gyeonggi-do (KR)

(72) Inventors: Sujeong KOH, Yongin-si (KR); Dahyun KIM, Yongin-si (KR); Myunghoon KIM, Yongin-si (KR); Sanghyung KIM, Yongin-si (KR); Sanghoon KIM, Yongin-si (KR); Hyejin PARK, Yongin-si (KR); Seungryong OH, Yongin-si (KR)

(21) Appl. No.: 17/904,943

(22) PCT Filed: Jan. 20, 2021
(86) PCT No.: PCT/KR2021/000801

§ 371 Date: Aug. 24, 2022

(30) Foreign Application Priority Data
Mar. 24, 2020 (KR) 10-2020-0035650

(51) Int. Cl. H01M 10/0567; H01M 10/0525; H01M 10/0569; H01M 4/485; H01M 4/505; H01M 4/525; H01M 4/38; H01M 4/583; H01M 4/36; H01M 10/0568

(52) U.S. Cl. CPC H01M 10/0567; H01M 10/0525; H01M 10/0569; H01M 4/485; H01M 4/505; H01M 4/525; H01M 4/386; H01M 4/583; H01M 4/364; H01M 10/0568; H01M 2004/028

(57) ABSTRACT

The present invention relates to a lithium secondary battery, the lithium secondary battery comprising: a cathode containing a cathode active material, an anode containing an anode active material; and an electrolyte containing a non-aqueous organic solvent, a lithium salt, and an additive represented by Chemical Formula 1, wherein the lithium secondary battery has a volume of 16 cm³ to 84 cm³.

### CROSS-REFERENCE TO RELATED APPLICATIONS

This application is a U.S. National Phase patent Application of International Patent Application Number PCT/KR2021/000801, filed on Jan. 20, 2021, which claims priority to Korean Patent Application Number 10-2020-0035650, filed on Mar. 24, 2020, the entire content of each of which is incorporated herein by reference.

### TECHNICAL FIELD

This relates to a lithium secondary battery.

### BACKGROUND ART

Lithium secondary batteries are attracting attention as power sources for various electronic devices because of high discharge voltage and high energy density.

As for cathode active materials of lithium secondary batteries, a lithium-transition metal oxide having a structure capable of intercalating lithium ions such as LiCoO₂, LiMn₂O₄, LiNi₁₋ₓCoₓO₂ (0<x<1), and the like has been used.

As for anode active materials, various carbon-based materials such as artificial graphite, natural graphite, and hard carbon capable of intercalating and deintercalating lithium ions have been mainly used.

As for electrolytes of lithium secondary batteries, an organic solvent in which a lithium salt is dissolved has been used.

### Technical Problem

One embodiment provides a lithium secondary battery being capable of suppressing on exothermic reaction during overcharging and reducing a heat value, thereby exhibiting improved safety.

### Technical Solution

According to one embodiment, a lithium secondary battery including a cathode including: a cathode active material; an anode including an anode active material; and an electrolyte including a non-aqueous organic solvent, a lithium salt, and an additive represented by Chemical Formula 1, wherein the lithium secondary battery has a volume of 16 cm³ to 84 cm³, is provided.

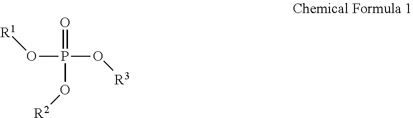

In Chemical Formula 1, R¹ to R³ are each independently a substituted or unsubstituted alkyl group, a substituted or unsubstituted alkenyl group, a substituted or unsubstituted aryl group. In one embodiment, R¹ to R³ may be a substituted or unsubstituted with an aryl group.

The additive represented by Chemical Formula 1 may be triphenyl phosphate (TPP), triethyl phosphate, diethyl allyl phosphate, 2-ethylhexyl diphenyl phosphate, or a combination thereof, and according to one embodiment, it may be triphenyl phosphate.

An amount of the additive may be 0.1 wt % to 10 wt % based on the total weight of the electrolyte.

The electrolyte may further include an additive for improving cycle-life represented by Chemical Formula 2.

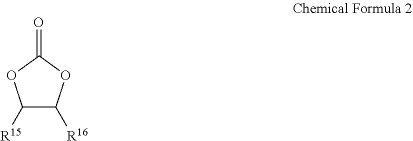

(In Chemical Formula 2, R¹⁵ and R¹⁶ are each independently selected from hydrogen, a halogen, a cyano group (CN), a nitro group (NO₂), or a fluorinated C1 to C5 alkyl group, provided that at least one of the R¹⁵ and R¹⁶ is selected from a halogen, a cyano group (CN), a nitro group (NO₂), or a fluorinated C1 to C5 alkyl group, and R¹⁵ and R¹⁶ are not simultaneously hydrogen.)

An amount of the additive for improving cycle-life may be 10 wt % to 20 wt % based on the total, 100 wt % of the electrolyte.

The lithium secondary battery may be a cylindrical battery having a diameter of 1.8 cm to 3.2 cm and a height of 6.5 cm to 10.5 cm, or a rectangular battery of a thickness of 0.54 cm to 0.7 cm, a width of 4.4 cm to 7.4 cm, and a height of 5.1 cm to 10 cm.

The non-aqueous organic solvent may include 50 volume % to 95 volume % of linear carbonate, linear ester or a combination thereof, and 5 volume % to 50 volume % of cyclic carbonate.

The positive active material may be at least one lithium composite oxide represented by Chemical Formula 3.

LiₐM¹_{1-y1-z1}M²_{y1}M³_{z1}O₂ Chemical Formula 3

(In Chemical Formula 3,

0.9≤a≤1.8, 0≤y≤1, 0≤1, 0≤z1≤1, 0≤y≤1+z1≤1, M¹, M², and M³ are each independently one selected from a metal of Ni, Co, Mn, Al, Sr, Mg or La, etc., or a combination thereof.)

The negative active material may include a Si-composite including a Si-based active material and a carbon-based active material. According to one embodiment, the negative active material may further include crystalline carbon.

Other embodiments are included in the following detailed description.

### Advantageous Effects

A lithium secondary battery according to one embodiment of the present invention may exhibit excellent battery safety during overcharging.

### BRIEF DESCRIPTION OF THE DRAWING

FIG. 1 is a schematic view showing a structure of the lithium secondary battery according to one embodiment.

### MODE FOR INVENTION

Hereinafter, embodiments of the present invention are described in detail. However, these embodiments are examples, the present invention is not limited thereto, and the present invention is defined by the scope of claims.

One embodiment provides a lithium secondary battery including a cathode including a cathode active material; an anode including an anode active material; and an electrolyte including a non-aqueous organic solvent, a lithium salt, and an additive represented by Chemical Formula 1, and the lithium secondary battery has a volume of 16 cm³ to 84 cm³.

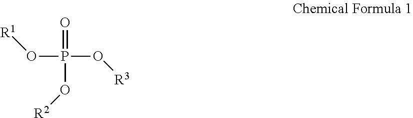

In Chemical Formula 1, R¹ to R³ are each independently a substituted or unsubstituted alkyl group, a substituted or unsubstituted alkenyl group, or a substituted or unsubstituted aryl group. In one embodiment, R¹ to R³ may be a substituted or unsubstituted with an aryl group.

In one embodiment, the alkyl group may be a C2 to C6 alkyl group, the alkenyl group may be a C2 to C6 alkenyl group, the aryl group may be a C6 to C20 aryl group.

In one embodiment, the substituent may be an alkyl group, a halogen group, an aromatic group, an amine group, or an amide or a nitrile group. Herein, the alkyl group may be a C2 to C6 alkyl group, and the aromatic group may be a C6 to C20 aromatic group. Furthermore, the halogen group may be F, Cl, Br, I, or a combination thereof.

An example of the additive represented by Chemical Formula 1 may be triphenyl phosphate of Chemical Formula 1a, triethyl phosphate, diethyl allyl phosphate, 2-ethylhexyl diphenyl phosphate or a combination thereof, and according to one embodiment, it may be triphenyl phosphate.

When the battery including the additive of Chemical Formula 1 is overcharged, the additive may be decomposed to form a thin film on a cathode, thereby suppressing the reaction between the interface of the active material and the electrolyte. Accordingly, the exothermic reaction caused by the reaction between the interface of the active material and the electrolyte may be suppressed and the heat value may be reduced, and thus, the battery safety may be secured. Furthermore, it is desired that the formation of the thin film on the cathode may be formed as a rigid polymeric thin film owing to a phenyl group (benzene ring) when R1 to R3 are all aryl groups in Chemical Formula 1, and thus, the reaction between the interface of the active material and the electrolyte may be effectively suppressed.

Such an effect for improving safety during overcharging by using the electrolyte including the additive of Chemical Formula 1 may be obtained by applied it to a battery having a volume of 16 cm³ to 84 cm³. This is that in case of the battery having a large volume of 16 cm³ to 84 cm³, the relative amounts of the active material and the electrolyte are also increased which causes an increase in the side reaction of the active material and the electrolyte and thus, the exothermic reaction is also severely increased to deteriorate safety, but such shortcomings may be effectively prevented by using the electrolyte including the additive of Chemical Formula 1.

Because a battery having a volume of less than 16 cm³ does not severely produce the exothermic reaction, the effects for improving safety during overcharging are insignificant. In addition, as the battery having a volume of more than 84 cm³ has a relatively small battery surface area, the exothermic passage generated during overcharging may be reduced. Thus, it causes to require severe ability for conserving heat, so that before the effects using the electrolyte including the additive of Chemical Formula 1 are realized, the heat generation and the shortcomings related thereto may more rapidly and extremely occur, and thus, the effects for improving safety using the additive of Chemical Formula 1 during overcharging, may not be obtained.

In one embodiment, the amount of the additive may be 0.1 wt % to 5 wt % based on the total weight of the electrolyte. When the amount of the additive is within the above range, the effects for improving safety during overcharging by using it in the battery having a volume of 16 cm³ to 84 cm³ may be more effectively obtained. If the amount of the additive is less than 0.1 wt %, the effects for improving safety during overcharging is slightly insignificant, and if the amount is more than 5 wt %, the cycle-life may be deteriorated and the resistance may be increased.

Such a lithium secondary battery with the volume may be a cylindrical battery having a diameter of 1.8 cm to 3.2 cm and a height of 6.5 cm to 10.5 cm and a rectangular battery having a thickness of 0.54 cm to 0.7 cm, a width of 4.4 cm to 7.4 cm, and a height of 5.1 cm to 10 cm.

The electrolyte may further include an additive for improving cycle-life together with the additive.

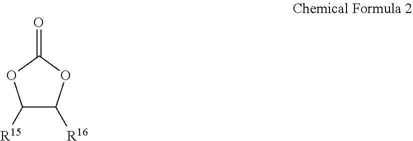

(In Chemical Formula 2, R¹⁵ and R¹⁶ are each independently selected from hydrogen, a halogen, a cyano group (CN), a nitro group (NO₂), or a fluorinated C1 to C5 alkyl group, provided that at least one of the R¹⁵ and R¹⁶ is selected from a halogen, a cyano group (CN), a nitro group (NO₂), or a fluorinated C1 to C5 alkyl group, and R¹⁵ and R¹⁶ are not simultaneously hydrogen.)

The example of the cycle-life improvement additive of Chemical Formula 2 may be difluoro ethylene carbonate, chloroethylene carbonate, dichloroethylene carbonate, bromoethylene carbonate, dibromoethylene carbonate, nitroethylene carbonate, cyanoethylene carbonate, fluoroethylene carbonate, or a combination thereof.

The compound of Chemical Formula 2 is the additive for improving the cycle-life, unlike Chemical Formula 1, and the compound of Chemical Formula 2 is not decomposed during overcharging so that it has no role to inhibit the reaction between the interface of the active material and the electrolyte due to the formation of a thin film. Therefore, the compound of Chemical Formula 2 has no role for improving safety during overcharging.

In one embodiment, if the electrolyte includes the additive of Chemical Formula 1 and the cycle-life improvement additive of Chemical Formula 2, the safety may be improved during overcharge and the cycle-life characteristics may be improved.

The amount of the cycle-life improvement additive may be 5 wt % to 20 wt % based on the total 100 wt % of the electrolyte. When the amount of the cycle-life improvement additive is within the above range, the cycle-life characteristics may be effectively improved.

The non-aqueous organic solvent serves as a medium for transmitting ions taking part in the electrochemical reaction of a battery.

In one embodiment, the non-aqueous organic solvent may include a linear carbonate, a linear ester, or a combination thereof (hereinafter, referred to as “linear solvent”), and may also include a cyclic carbonate, and herein, an amount of the linear carbonate, the linear ester, or a combination thereof may be 50 volume % to 95 volume % and an amount of the cyclic carbonate may be 5 volume % to 50 volume %.

In the non-aqueous organic solvent, the amounts of the linear solvent and the cyclic carbonate are within the above range, the advantageous from use of the linear solvent and the cyclic carbonate may be both realized, so that the ionic conductivity may be better, thereby maximizing the performances of the lithium secondary battery.

The linear carbonate may be dimethyl carbonate (DMC), diethyl carbonate (DEC), dipropyl carbonate (DPC), methyl propyl carbonate (MPC), ethylpropyl carbonate (EPC), ethyl methyl carbonate (EMC), or a combination thereof.

The linear ester may be ethyl propionate (EP), propyl propionate (PP), or a combination thereof.

The cyclic carbonate may be ethylene carbonate (EC), propylene carbonate (PC), butylene carbonate (BC), or a combination thereof.

The non-aqueous organic solvent may further include ester-based, ether-based, ketone-based, alcohol-based, aprotic solvent, and aromatic hydrocarbon-based organic solvent which are generally used as a non-aqueous solvent of the lithium secondary battery, in addition to the linear solvent and the cyclic-carbonate.

When the ester-based, the ketone-based, the alcohol-based, the aprotic solvent or the aromatic hydrocarbon-based organic solvent is further used, the amount thereof may be suitably controlled.

As the ester-based solvent, methyl acetate, ethyl acetate, n-propyl acetate, t-butyl acetate, methylpropionate, γ-butyrolactone, decanolide, valerolactone, mevalonolactone, caprolactone, and the like, may be used.

As the ether-based solvent, dibutyl ether, tetraglyme, diglyme, dimethoxyethane, 2-methyltetrahydrofuran, tetrahydrofuran, and the like, may be used, and as the ketone-based solvent, cyclohexanone and the like, may be used.

As the alcohol-based solvent, ethanol, isopropyl alcohol, and the like, may be used, and as the aprotic solvent, nitriles such as T-CN (wherein T is a C2 to C20 linear, branched, or cyclic hydrocarbon group, or may include a double bond aromatic ring, or an ether bond), amides such as dimethylformamide and the like, dioxolanes such as 1,3-dioxolane and the like, and sulfolane and the like, may be used.

As the aromatic hydrocarbon-based organic solvent, an aromatic hydrocarbon-based compound of Chemical Formula 4 may be used.

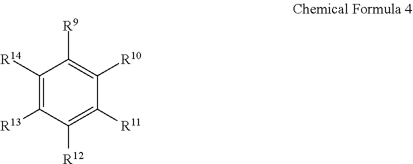

(In Chemical Formula 4, R⁹ to R¹⁴ are the same or different, and are selected from the group consisting of hydrogen, a halogen, a C1 to C10 alkyl group, a haloalkyl group, and a combination thereof.)

Specific examples of the aromatic hydrocarbon-based organic solvent may be selected from the group consisting of benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triodotoluene, 2,3,5-triodotoluene, xylene, and a combination thereof.

The lithium salt dissolved in an organic solvent supplies a battery with lithium ions, basically operates the lithium secondary battery, and improves transportation of the lithium ions between a cathode and an anode. Exemplary of the lithium salt include one or two or more of LiPF₆, LiSbF₆, LiAsF₆, LiPO₂F₂, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiN(CₓF_{2y+1}SO₂)(C_{y}F_{2y+1}SO₂) (wherein x and y are natural numbers, for example an integer of 1 to 20), lithium difluoro(bisoxolato) phosphate), LiCl, LiI, LiB(C₂O₄)₂ (lithium bis(oxalato) borate: LiBOB), lithium difluoro(oxalato)borate (LiDFOB), as a supporting electrolyte salt. A concentration of the lithium salt may range from 0.1 M to 2.0 M. When the lithium salt is included at the above concentration range, an electrolyte may have excellent performance and effective lithium ion mobility due to optimal electrolyte conductivity and viscosity.

Another embodiment provides a lithium secondary battery including the electrolyte, a cathode, and a negative electrode.

The cathode includes a current collector and a cathode active material layer formed on the current collector, and includes a cathode active material.

In the cathode active material layer, as the cathode active material, a compound being capable of reversibly intercalating and deintercalating lithium (a lithiated intercalation compound) may be used, and as a specific example, one or more composite oxides of a metal selected from cobalt, manganese, nickel, or a combination thereof, and lithium, may be used. As more specific examples, compounds represented by one of the following chemical formulae may be used. Liₐ A_{1-b}X_{b}D₂ (0.90≤a≤1.8, 0≤b≤0.5); Liₐ A_{1-b}X_{b}O_{2-c}D_{c} (0.90≤a≤1.8, 0≤b≤0.5, 0≤c≤0.05); Liₐ E_{1-b}X_{b}O_{2-c}D_{c} (0≤b≤0.5, 0≤b≤5≤c≤0.05); Liₐ E_{2-b}X_{b}O_{4-c}D_{c} (0≤b≤5≤b≤0.5, 0≤b≤5≤c≤0.05); Liₐ Ni_{1-b-c}Co_{b}X_{c}D_{α} (0.90≤b≤5≤a≤1.8, 0≤b≤5 b≤0.5, 0≤b≤5≤c≤0.5, 0<α≤2); Liₐ Ni_{1-b-c}Co_{b}X_{c}O_{2-α}T_{α} (0.90≤a≤1.8, 0≤b≤0.5, 0≤c≤0.5, 0<α≤2); Liₐ Ni_{1-b-c}Co_{b}X_{c}O_{2-α}T₂ (0.90≤a≤1.8, 0≤b≤0.5, 0≤c≤0.5, 0<α≤2); LiₐN_{1-c}Mn_{b}X_{c}Dₐ(0.90≤a≤1.8, 0≤b≤0.5, 0≤c≤0.5, 0<α≤2); LiₐN_{1-b-c}MₙXO_{2-α}T_{α} (0.905≤a≤1.8, 0≤b≤0≤c≤0≤c≤0.5, 0<α<2); LiₐN_{1-b-c}Mn_{b}X_{c}O_{2-α}T₂ (0.90≤a≤1.8, 0≤b≤0.5, 0≤b≤5≤c≤0.5, 0<α<2); Liₐ Ni_{b}E_{c}G_{d}O₂ (0.90≤a≤1.8, 0≤b≤0.9, 0≤c≤0.5, 0.001≤d≤0.1); Liₐ Ni_{b}Co_{c}Mn_{d}GₑO₂ (0.90≤a≤1.8, 0≤b≤0.9, 0≤c≤0.5, 0≤d≤0.5, 0.001≤e≤0.1); LiₐMn_{1-G}bO₂ (0.90≤a≤1.8, 0.001≤b≤0.1) Liₐ CoG_{b}O₂ (0.90≤a≤1.8, 0.001≤b≤0.1); Liₐ Mn_{1-b}G_{b}O₂ (0.90≤a≤1.8, 0.001≤b≤0.1); Liₐ Mn₂G_{b}O₄ (0.90≤a≤1.8, 0.001≤b≤0.1); Liₐ Mn_{1-g}G_{g}PO₄ (0.90≤a≤1.8, 0≤g≤0.5); QO₂; QS₂; LiQS₂V₂O₅; LIV₂O₅; LiZO₂; LiNiVO₄Li_{(3-f)}J₂PO₄₃ (0≤b≤5 f≤2); Li_{(3-f)}Fe₂PO₄₃ (0≤f≤2); Liₐ FePO₄ (0.90≤a≤1.8)

In the chemical formulae, A is selected from Ni, Co, Mn, or a combination thereof; X is selected from Al, Ni, Co, Mn, Cr, Fe, Mg, Sr, V, a rare earth element, or a combination thereof; D is selected from O, F, S, P, or a combination thereof; E is selected from Co, Mn, or a combination thereof; T is selected from F, S, P, or a combination thereof; G is selected from Al, Cr, Mn, Fe, Mg, La, Ce, Sr, V, or a combination thereof; Q is selected from Ti, Mo, Mn, or a combination thereof; Z is selected from Cr, V, Fe, Sc, Y, or a combination thereof; and J is selected from V, Cr, Mn, Co, Ni, Cu, or a combination thereof.

The compounds may also have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in any method having no adverse influence on properties of a cathode active material by using these elements in the compound (for example, spray coating, dipping, and the like), but is not illustrated in more detail since it is well-known in the related field.

In the cathode, an amount of the cathode active material may be about 90 wt % to about 98 wt % based on a total weight of the cathode active material layer.

In one embodiment, the cathode active material layer may further include a binder and a conductive material. Herein, each amount of the binder and the conductive material may be about 1 wt % to about 5 wt % based on the total weight of the cathode active material layer.

The binder improves binding properties of cathode active material particles with one another and with a current collector, and examples thereof may be polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, nylon, and the like, but are not limited thereto.

The conductive material may be a carbon-based conductive material, and it is desired that the carbon-based conductive material is used as the cathode conductive material of the lithium secondary battery including the electrolyte with the additive of Chemical Formula 1 according to one embodiment, as it has better conductivity than a metal-based conductive lithium secondary battery. That is, the lithium secondary battery including the additive of Chemical Formula 1 including the cathode having the carbon-based conductive material may exhibit good conductivity.

The current collector may be an aluminum foil, a nickel foil, or a combination thereof, but is not limited thereto.

The anode includes a current collector and an anode active material layer formed on the current collector and including an anode active material.

The anode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may be a carbon material, and may be any carbon-based anode active material that is generally used in a lithium secondary battery. Examples of the carbon-based anode active material may be crystalline carbon, amorphous carbon, or a combination thereof.

Examples of the crystalline carbon may be a graphite such as an unspecified shape, sheet shaped, flake shaped, spherically shaped, or fiber shaped natural graphite or artificial graphite, and examples of the amorphous carbon may be soft carbon or hard carbon, a mesophase pitch carbonized product, fired cokes, and the like.

The lithium metal alloy may include an alloy of lithium and a metal selected from the group consisting of Na, K, Rb, Cs, Fr, Be, Mg, Ca, Sr, Si, Sb, Pb, In, Zn, Ba, Ra, Ge, Al, and Sn.

The material capable of doping and dedoping lithium may be Si, a Si—C composite, SiOₓ (0<x<2), a Si-Q alloy (wherein Q is an element selected from the group consisting of an alkali metal, an alkaline-earth metal, a Group 13 element, a Group 14 element, a Group 15 element, a Group 16 element, a transition element, a rare earth element, and a combination thereof, and not Si), Sn, SnO₂, a Sn—R alloy (wherein R is an element selected from the group consisting of an alkali metal, an alkaline-earth metal, a Group 13 element, a Group 14 element, a Group 15 element, a Group 16 element, a transition element, a rare earth element, and a combination thereof, and not Sn), and the like, and at least one thereof may be mixed with SiO₂. The elements Q and R may be selected from the group consisting of Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The transition metal oxide may be lithium titanium oxide.

The anode active material according to one embodiment may include a Si—C composite including a Si-based active material and a carbon-based active material.

The silicon-based active material may have an average particle diameter of 50 nm to 200 nm.

When the particle diameter of the Si particle is within the range, volume expansion caused during charge and discharge may be suppressed, and breakage of the conductive path due to crushing of particles may be prevented.

The Si-based active material may be included in amount of 1 to 60 wt % based on the total weight of the Si—C composite, and for example 3 to 60 wt %.

The anode active material layer may include an anode active material and a binder, and may optionally further include a conductive material.

In the anode active material layer, the anode active material may be included in an amount of about 95 wt % to about 99 wt % based on the total weight of the anode active material layer. In the anode active material layer, a weight of the binder may be about 1 wt % to about 5 wt % based on the total weight of the anode active material layer. Furthermore, in case of further including a conductive material, the anode active material layer includes about 90 wt % to about 98 wt % of the anode active material, about 1 wt % to about 5 wt % of the binder, and about 1 wt % to about 5 wt % of the conductive material.

The binder improves binding properties of negative active material particles with one another and with a current collector. The binder includes a non-water-soluble binder, a water-soluble binder, or a combination thereof.

The non-water-soluble binder may include an ethylene propylene copolymer, polyacrylonitrile, polystyrene, polyvinylchloride, carboxylated polyvinyl chloride, polyvinyl fluoride, polyurethane, polytetrafluoroethylene, polyvinylidene fluoride, polyethylene, polypropylene, polyamideimide, polyimide, or a combination thereof.

The water-soluble binder may include a styrene-butadiene rubber, an acrylated styrene-butadiene rubber, an acrylonitrile-butadiene rubber, an acryl rubber, a butyl rubber, a fluorine rubber, an ethylene oxide-containing polymer, polyvinylpyrrolidone, polyepichlorohydrin, polyphosphazene, an ethylene propylene diene copolymer, polyvinylpyridine, chlorosulfonated polyethylene, latex, a polyester resin, an acryl resin, a phenol resin, an epoxy resin, polyvinyl alcohol, or a combination thereof.

When the water-soluble binder is used as a negative electrode binder, a cellulose-based compound may be further used to provide viscosity as a thickener. The cellulose-based compound includes one or more of carboxylmethyl cellulose, hydroxypropyl methyl cellulose, methyl cellulose, or alkali metal salts thereof. The alkali metal may be Na, K, or Li. The thickener may be included in an amount of about 0.1 parts by weight to about 3 parts by weight based on 100 parts by weight of the negative active material.

The conductive material is included to provide electrode conductivity, and any electrically conductive material may be used as a conductive material unless it causes a chemical change. Examples of the conductive material may include a carbon-based material such as natural graphite, artificial graphite, carbon black, acetylene black, ketjen black, denka black, carbon fiber, and the like; a metal-based material of a metal powder or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof, but is not limited thereto.

The cathode active material layer and the anode active material layer may be formed by mixing an anode active material, a binder, and optionally a conductive material in a solvent to prepare each active material composition, and applying the active material composition to a current collector. Since such a method for forming an active material layer is widely known in the art, a detailed description thereof will be omitted herein. The solvent includes N-methylpyrrolidone and the like, but is not limited thereto. In addition, when a water-soluble binder is used for the anode active material layer, water may be used as a solvent used in preparing the anode active material composition.

Furthermore, depending on a kind of the lithium secondary battery, a separator may also be positioned between the cathode and the anode. Examples of a separator include polyethylene, polypropylene, polyvinylidene fluoride, and multi-layers of two or more layers thereof, and may also include mixed multi-layers such as a polyethylene/polypropylene double-layered separator, a polyethylene/polypropylene/polyethylene triple-layered separator, and a polypropylene/polyethylene/polypropylene triple-layered separator.

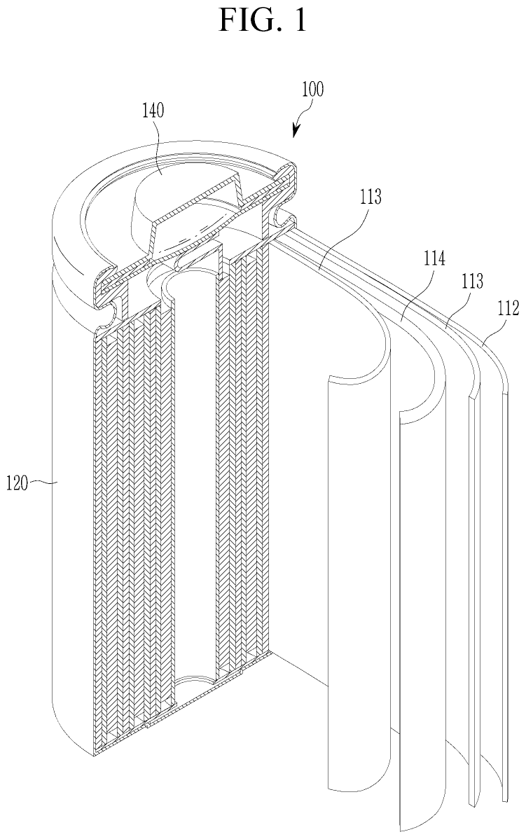

FIG. 1 is an exploded perspective view of a lithium secondary battery according to one embodiment. The lithium secondary battery according to an embodiment is illustrated as a prismatic battery, but is not limited thereto, and may include variously-shaped batteries such as a cylindrical battery, a pouch battery, and the like.

FIG. 1 schematically shows the structure of the lithium secondary battery according to one embodiment. Referring to FIG. 1, a lithium secondary battery 100 according to an embodiment includes: a battery assembly including a positive electrode 114, a negative electrode 112 facing the positive electrode 114, a separator 113 disposed between the positive electrode 114 and the negative electrode 112, and an electrolyte (not shown) immersed in the positive electrode 114, the negative electrode 112, and the separator 113; a battery case 120 housing the battery assembly; and a sealing member 140 sealing the battery case 120.

### EXAMPLES FOR PERFORMING INVENTION

Hereinafter, examples of the present invention and comparative examples are described. These examples, however, are only examples of the present invention, and the present invention is not limited thereto.

### Fabrication of Rectangular Lithium Secondary Cell

### Comparative Example 1

1.15 M LiPF₆ was added to a mixed solvent of ethylene carbonate, propylene carbonate, diethyl carbonate and ethyl propionate (1:2:5:2 volume ratio), and 6 wt % of fluoroethylene carbonate was added to 100 wt % of the resulting mixture to prepare an electrolyte for a lithium secondary cell.

96 wt % of a LiNi_{0.88}Co_{0.105}Al_{0.015}O₂ positive active material, 2 wt % of a ketjen black conductive material and 2 wt % of a polyvinylidene fluoride binder were mixed in an N-methylpyrrolidone solvent to prepare a cathode active material slurry. The cathode active material slurry was coated on an aluminum foil, dried and compressed to prepare a cathode.

A mixture of graphite and a Si—C composite at a 89:11 weight ratio as an anode active material, styrene-butadiene rubber as a binder and carboxylmethyl cellulose were mixed at a weight ratio of 98:1:1 and dispersed in distilled water to prepare a anode active material slurry.

The Si—C composite had a core including artificial graphite and silicon particles, and coal pitch coated on the core, and herein, the amount of silicon was 3 wt % based on the total weight of the Si-carbon composite.

The anode active material slurry was coated on a copper foil, dried, and compressed to produce an anode.

Using the electrolyte, the cathode, and the anode, a rectangular lithium secondary cell having a volume of 8 cm³ (thickness: 0.46 cm, width: 3.6 cm and height: 5.1 cm) was fabricated according to the general procedure.

### Comparative Example 2

A rectangular lithium secondary cell having a volume of 20 cm³ (thickness: 0.54 cm, width: 4.4 cm, and height: 8.6 cm) was fabricated by the general procedures using the electrolyte of Comparative Example 1 and the cathode and the anode of Example 1.

### Comparative Example 3

A rectangular lithium secondary cell having a volume of 35 cm³ (thickness: 0.44 cm, width: 8 cm, and height: 10 cm) was fabricated by the general procedures using the electrolyte of Comparative Example 1 and the cathode and the anode of Example 1.

### Comparative Example 4

A rectangular lithium secondary cell having a volume of 44 cm³ (thickness: 0.66 cm, width: 7.4 cm, and height: 9 cm) was fabricated by the general procedures using the electrolyte of Comparative Example 1 and the cathode and the anode of Example 1.

### Comparative Example 5

A rectangular lithium secondary cell having a volume of 60 cm³ (thickness: 0.7 cm, width: 7.4 cm, and height: 11.5 cm) was fabricated by the general procedures using the electrolyte of Comparative Example 1 and the cathode and the anode of Example 1.

### Comparative Example 6

A rectangular lithium secondary cell having a volume of 108 cm³ (thickness: 1.3 cm, width: 8 cm, and height: 10 cm) was fabricated by the general procedures using the electrolyte of Comparative Example 1 and the cathode and the anode of Example 1.

### Comparative Example 7

A rectangular lithium secondary cell having a volume of 115 cm³ (thickness: 1.3 cm, width: 7.7 cm, and height: 11.5 cm) was fabricated by the general procedures using the electrolyte of Comparative Example 1 and the cathode and the anode of Example 1.

### Comparative Example 8

1.15 M LiPF₆ was added to a mixed solvent of ethylene carbonate, propylene carbonate, diethyl carbonate and ethyl propionate (1:2:5:2 volume ratio), 2 wt % of an additive of Chemical Formula 1a and 6 wt % of fluoroethylene carbonate were added to 100 wt % of the resulting mixture to prepare an electrolyte for a lithium secondary cell.

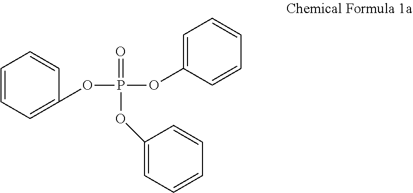 [SMILES: O=P(Oc1ccccc1)(Oc1ccccc1)Oc1ccccc1]

96 wt % of a LiNi_{0.88}Co_{0.105}Al_{0.015}O₂ positive active material, 2 wt % of a ketjen black conductive material and 2 wt % of a polyvinylidene fluoride binder were mixed in an N-methylpyrrolidone solvent to prepare a cathode active material slurry. The cathode active material slurry was coated on an aluminum foil, dried and compressed to prepare a cathode.

A mixture of graphite and a Si—C composite at an 89:11 weight ratio as an anode active material, styrene-butadiene rubber as a binder and carboxylmethyl cellulose were mixed at a weight ratio of 98:1:1 and dispersed in distilled water to prepare an anode active material slurry.

The Si—C composite had a core including artificial graphite and silicon particles, and petroleum pitch coated on the core, and herein, the amount of silicon was 3 wt % based on the total weight of the Si-carbon composite.

The anode active material slurry was coated on a copper foil, dried, and compressed to produce an anode.

Using the electrolyte, the cathode, and the anode, a rectangular lithium secondary cell having a volume of 8 cm³ (thickness: 0.46 cm, width: 3.6 cm and height: 5.1 cm) was fabricated.

### Example 1

1.15M LiPF₆ was added to a mixed solvent of ethylene carbonate, propylene carbonate, diethyl carbonate and ethyl propionate (1:2:5:2 volume ratio), 2 wt % of an additive of Chemical Formula 1a and 6 wt % of fluoroethylene carbonate were added to 100 wt % of the resulting mixture to prepare an electrolyte for a lithium secondary cell.

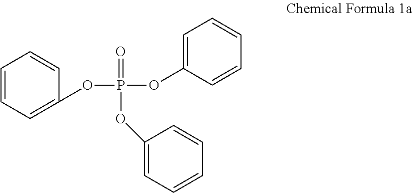 [SMILES: O=P(Oc1ccccc1)(Oc1ccccc1)Oc1ccccc1]

96 wt % of a LiNi_{0.88}Co_{0.105}Al_{0.015}O₂ positive active material, 2 wt % of a ketjen black conductive material and 2 wt % of a polyvinylidene fluoride binder were mixed in an N-methylpyrrolidone solvent to prepare a cathode active material slurry. The cathode active material slurry was coated on an aluminum foil, dried and compressed to prepare a cathode.

A mixture of graphite and a Si—C composite at an 89:11 weight ratio as an anode active material, styrene-butadiene rubber as a binder and carboxylmethyl cellulose were mixed at a weight ratio of 98:1:1 and dispersed in distilled water to prepare an anode active material slurry.

The Si—C composite had a core including artificial graphite and silicon particles, and petroleum pitch coated on the core, and herein, the amount of silicon was 3 wt % based on the total weight of the Si-carbon composite.

The anode active material slurry was coated on a copper foil, dried, and compressed to produce an anode.

Using the electrolyte, the cathode, and the anode, a rectangular lithium secondary cell having a volume of 20 cm³ (thickness: 0.54 cm, width: 4.4 cm and height: 8.6 cm) was fabricated.

### Example 2

A rectangular lithium secondary cell having a volume of 35 cm³ (thickness: 0.44 cm, width: 8 cm, and height: 10 cm) was fabricated by the conventional procedures using the electrolyte, the cathode and the anode of Example 1.

### Example 3

A rectangular lithium secondary cell having a volume of 44 cm³ (thickness: 0.66 cm, width: 7.4 cm, and height: 9 cm) was fabricated by the conventional procedures using the electrolyte, the cathode, and the anode of Example 1.

### Example 4

A rectangular lithium secondary cell having a volume of 60 cm³ (thickness: 0.7 cm, width: 7.4 cm, and height: 11.5 cm) was fabricated by the conventional procedures using the electrolyte, the cathode, and the anode of Example 1.

### Comparative Example 9

A rectangular lithium secondary cell having a volume of 104 cm³ (thickness: 1.3 cm, width: 8 cm, and height: 10 cm) was fabricated by the conventional procedures using the electrolyte of Comparative Example 8, and the cathode and the anode of Example 1.

### Comparative Example 10

A rectangular lithium secondary cell having a volume of 115 cm³ (thickness: 1.3 cm, width: 7.7 cm, and height: 11.5 cm) was fabricated by the general procedures using the electrolyte of Comparative Example 8, and the cathode and the anode of Example 1.

Overcharge Test

The lithium secondary cells according to Examples 1 to 4 and Comparative Examples 1 to 10 were discharged at 0.2 C and 2.5 V, and charged to 2 C, 12 V to confirm voltage, current, temperature, and appearance of the cells. The results are shown in Table 1 as thermal stability depended on the following standard. Furthermore, the amounts of the cycle-life improvement additive of the electrolyte and the additive and the battery volume are also shown in Table 1.

In Table 1, LX (X=0 to 5) indicates battery safety, and as X is smaller, a battery cell is safer.

TABLE 1
L0: no change
L1: leakage
L2: smoke
L4: exothermic at 200° C. or more
L5: explosion

| | Amount of | | | |
|---|---|---|---|---|
| | fluoroethylene | Amount | | |
| | carbonate as cycle-life | of | Cell | |
| | improvement additive | additive | volume | Safety |
| | (wt %) | (wt %) | (cm³) | evaluation |
| Comparative | 6 | 0 | 8 | L5 |
| Example 1 | | | | |
| Comparative | 6 | 0 | 20 | L5 |
| Example 2 | | | | |
| Comparative | 6 | 0 | 35 | L5 |
| Example 3 | | | | |
| Comparative | 6 | 0 | 44 | L5 |
| Example 4 | | | | |
| Comparative | 6 | 0 | 60 | L5 |
| Example 5 | | | | |
| Comparative | 6 | 0 | 104 | L5 |
| Example 6 | | | | |
| Comparative | 6 | 0 | 115 | L5 |
| Example 7 | | | | |
| Comparative | 6 | 2 | 8 | L5 |
| Example 8 | | | | |
| Example 1 | 6 | 2 | 20 | L0 |
| Example 2 | 6 | 3 | 35 | L0 |
| Example 3 | 6 | 2 | 44 | L1 |
| Example 4 | 6 | 2 | 60 | L1 |
| Comparative | 6 | 2 | 104 | L5 |
| Example 9 | | | | |
| Comparative | 15 | 2 | 115 | L5 |
| Example 10 | | | | |

As shown in Table 1, the lithium secondary cells according to Comparative Examples 2 to 5 using the electrolyte without the additive of Chemical Formula 1a and having a volume of 20 cm³ to 60 cm³ exhibited L5 as the result which indicated occurrence of explosion and very poor safety.

Meanwhile, Examples 1 to 4 in which lithium secondary cells were fabricated by using the electrolyte with the additive of Chemical Formula 1a to have a volume of 20 cm³ to 60 cm³, exhibited L0 or L1 as the overcharging results which indicated very improved safety.

In addition, although the electrolyte using the additive of Chemical Formula 1a was used, Comparative Examples 8, 9, and 10 in which the cell volume was very small, 8 cm³ or was very large, 104 cm³ and 115 cm³, exhibited L5 as the overcharging results which was the same to that of Comparative Examples 1, 6, and 7 using the electrolyte without the additive of Chemical Formula 1a.

From these results, the effects for improving safety during the overcharging from the use of additive of Chemical Formula 1a may be obtained from the lithium secondary cell with a volume of 16 cm³ to 84 cm³.

### Fabrication of Cylindrical Lithium Secondary Cell

### Comparative Example 11

1.15 M LiPF₆ was added to a mixed solvent of ethylene carbonate, ethyl methyl carbonate and dimethyl carbonate (2:1:7 volume ratio) and 15 wt % of fluoroethylene carbonate was added to 100 wt % of the resulting mixture to prepare an electrolyte for a lithium secondary cell.

96 wt % of a LiNi_{0.88}Co_{0.105}Al_{0.015}O₂ positive active material, 2 wt % of a ketjen black conductive material and 2 wt % of a polyvinylidene fluoride binder were mixed in an N-methylpyrrolidone solvent to prepare a cathode active material slurry. The cathode active material slurry was coated on an aluminum foil, dried and compressed to prepare a cathode.

A mixture of graphite and a Si—C composite at an 89:11 weight ratio as an anode active material, styrene-butadiene rubber as a binder and carboxylmethyl cellulose were mixed at a weight ratio of 98:1:1 and dispersed in distilled water to prepare an anode active material slurry.

The Si—C composite had a core including artificial graphite and silicon particles, and coal pitch coated on the core, and herein, the amount of silicon was 3 wt % based on the total weight of the Si-carbon composite.

The anode active material slurry was coated on a copper foil, dried, and compressed to produce an anode.

Using the electrolyte, the cathode, and the anode, a cylindrical lithium secondary cell having a volume of 7 cm³ (diameter: 1.6 cm and height: 3.4 cm) was fabricated according to the general procedure.

### Comparative Example 12

A cylindrical lithium secondary cell having a volume of 13 cm³ (diameter: 1.8 cm and height: 5 cm) was fabricated by the general procedures using the electrolyte, the cathode and the anode of Comparative Example 11.

### Comparative Example 13

A cylindrical lithium secondary cell having a volume of 16 cm³ (diameter: 1.8 cm and height: 6.5 cm) was fabricated by the general procedures using the electrolyte, the cathode and the anode of Comparative Example 11.

### Comparative Example 14

A cylindrical lithium secondary cell having a volume of 24 cm³ (diameter: 2.1 cm and height: 7.0 cm) was fabricated by the general procedures using the electrolyte, the cathode and the anode of Comparative Example 11.

### Comparative Example 15

A cylindrical lithium secondary cell having a volume of 84 cm³ (diameter: 3.2 cm and height: 10.5 cm) was fabricated by the general procedures using the electrolyte, the cathode and the anode of Comparative Example 1.

### Comparative Example 16

A cylindrical lithium secondary cell having a volume of 177 cm³ (diameter: 7.5 cm and height: 4 cm) was fabricated by the general procedures using the electrolyte, the cathode and the anode of Comparative Example 1.

### Comparative Example 17

1.15 M LiPF₆ was added to a mixed solvent of ethylene carbonate, ethyl methyl carbonate, and dimethyl carbonate (2:1:7 volume ratio), and 2 wt % of an additive of Chemical Formula 1a and 15 wt % of fluoroethylene carbonate were added to 100 wt % of the resulting mixture to prepare an electrolyte for a lithium secondary cell.

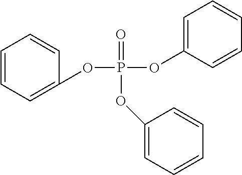 [SMILES: O=P(Oc1ccccc1)(Oc1ccccc1)Oc1ccccc1]

Using the electrolyte and the cathode and the anode of Comparative Example 11, a cylindrical lithium secondary cell having a volume of 7 cm³ (diameter: 1.6 cm and height: 3.4 cm) was fabricated according to the general procedure.

### Comparative Example 18

A cylindrical lithium secondary cell having a volume of 13 cm³ (diameter: 1.8 cm and height: 5 cm) was fabricated by the general procedures using the electrolyte of Comparative Example 17, and the cathode and the anode of Comparative Example 11.

### Example 5

1.15 M LiPF₆ was added to a mixed solvent of ethylene carbonate, ethyl methyl carbonate, and dimethyl carbonate (2:1:7 volume ratio), 2 wt % of an additive of Chemical Formula 1a, and 15 wt % of fluoroethylene carbonate were added to 100 wt % of the resulting mixture to prepare an electrolyte for a lithium secondary cell.

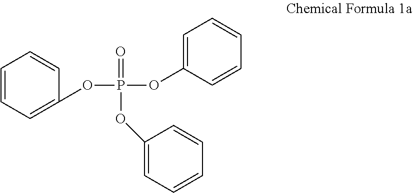 [SMILES: O=P(Oc1ccccc1)(Oc1ccccc1)Oc1ccccc1]

96 wt % of a LiNi_{0.88}Co_{0.105}Al_{0.015}O₂ positive active material, 2 wt % of a ketjen black conductive material and 2 wt % of a polyvinylidene fluoride binder were mixed in an N-methylpyrrolidone solvent to prepare a cathode active material slurry. The cathode active material slurry was coated on an aluminum foil, dried and compressed to prepare a cathode.

A mixture of graphite and a Si—C composite at an 89:11 weight ratio as an anode active material, styrene-butadiene rubber as a binder, and carboxylmethyl cellulose were mixed at a weight ratio of 98:1:1 and dispersed in distilled water to prepare an anode active material slurry.

The Si—C composite had a core including artificial graphite and silicon particles, and coal pitch coated on the core, and herein, the amount of silicon was 3 wt % based on the total weight of the Si-carbon composite.

The anode active material slurry was coated on a copper foil, dried, and compressed to produce an anode.

Using the electrolyte, the cathode, and the anode, a cylindrical lithium secondary cell having a volume of 16 cm³ (diameter: 1.8 cm and height: 6.5 cm) was fabricated according to the general procedure.

### Example 6

A cylindrical lithium secondary cell having a volume of 24 cm³ (diameter: 2.1 cm and height: 7.0 cm) was fabricated by the general procedures using the electrolyte, the cathode, and the anode of Example 5.

### Example 7

A cylindrical lithium secondary cell having a volume of 84 cm³ (diameter: 3.2 cm and height: 10.5 cm) was fabricated by the general procedures using the electrolyte, the cathode, and the anode of Example 5.

### Comparative Example 19

A cylindrical lithium secondary cell having a volume of 177 cm³ (diameter: 7.5 cm and height: 4 cm) was fabricated by the general procedures using the electrolyte, the cathode, and the anode of Example 5.

Overcharge Test

The lithium secondary cells according to Examples 5 to 7 and Comparative Examples 11 to 19 were discharged at 0.2 C and 2.5 V, and charged to 2 C, 12 V to confirm voltage, current, temperature, and appearance of the cells. The results are shown in Table 2 as thermal stability depended on the following standard. Furthermore, the amounts of the cycle-life improvement additive of the electrolyte and the additive and the battery volume are also shown in Table 2.

In Table 2, LX (X=0 to 5) indicates battery safety, and as X is smaller, a battery cell is safer.

TABLE 2
L0: no change
L1: leakage
L2: smoke
L4: exothermic at 200° C. or more
L5: explosion

| | Amount of | | | |
|---|---|---|---|---|
| | fluoroethylene | Amount | | |
| | carbonate as cycle-life | of | Cell | |
| | improvement additive | additive | volume | Safety |
| | (wt %) | (wt %) | (cm³) | evaluation |
| Comparative | 15 | 0 | 7 | L5 |
| Example 11 | | | | |
| Comparative | 15 | 0 | 13 | L5 |
| Example 12 | | | | |
| Comparative | 15 | 0 | 16 | L5 |
| Example 13 | | | | |
| Comparative | 15 | 0 | 24 | L5 |
| Example 14 | | | | |
| Comparative | 15 | 0 | 84 | L5 |
| Example 15 | | | | |
| Comparative | 15 | 0 | 177 | L5 |
| Example 16 | | | | |
| Comparative | 15 | 2 | 7 | L5 |
| Example 17 | | | | |
| Comparative | 15 | 2 | 13 | L5 |
| Example 18 | | | | |
| Example 5 | 15 | 2 | 16 | L1 |
| Example 6 | 15 | 2 | 24 | L0 |
| Example 7 | 15 | 2 | 177 | L1 |
| Comparative | 15 | 2 | 104 | L5 |
| Example 19 | | | | |

As shown in Table 2, the lithium secondary cells according to Comparative Examples 13 to 15 using the electrolyte without the additive of Chemical Formula 1a and having a volume of 16 cm³ to 84 cm³ exhibited L5 as the result which indicated occurrence of explosion and very poor safety.

Meanwhile, Examples 5 to 7 in which lithium secondary cells were fabricated by using the electrolyte with the additive of Chemical Formula 1a to have a volume of 16 cm³ to 84 cm³, exhibited L0 or L1 as the overcharging results which indicated very improved safety.

In addition, although the electrolyte using the additive of Chemical Formula 1a was used, Comparative Examples 17, 18, and 19 in which the cell volume was very small, 7 cm³ or 13 cm³, or was very large, 177 cm³, exhibited L5 as the overcharging results which was the same to that of Comparative Examples 11, 12, and 16 using the electrolyte without the additive of Chemical Formula 1a.

From these results, the effects for improving safety during the overcharging from the use of additive of Chemical Formula 1a may be obtained from the lithium secondary cell with a volume of 16 cm³ to 84 cm³.

### Comparison of Amount of Additive

### Example 8

A rectangular lithium secondary cell having a volume of 16 cm³ (thickness: 0.44 cm, width: 8 cm, and height: 10 cm) was fabricated by the same procedure as in Example 5, except that an amount of the additive of Chemical Formula 1a was changed from 2 wt % to 0.1 wt %.

### Example 9

A rectangular lithium secondary cell having a volume of 16 cm³ (thickness: 0.44 cm, width: 8 cm, and height: 10 cm) was fabricated by the same procedure as in Example 5, except that an amount of the additive of Chemical Formula 1a was changed from 2 wt % to 0.5 wt %.

### Example 10

A rectangular lithium secondary cell having a volume of 16 cm³ (thickness: 0.44 cm, width: 8 cm, and height: 10 cm) was fabricated by the same procedure as in Example 5, except that an amount of the additive of Chemical Formula 1a was changed from 2 wt % to 1 wt %.

### Example 11

A rectangular lithium secondary cell having a volume of 16 cm³ (thickness: 0.44 cm, width: 8 cm and height: 10 cm) was fabricated by the same procedure as in Example 5, except that an amount of the additive of Chemical Formula 1a was changed from 2 wt % to 3 wt %.

### Example 12

A rectangular lithium secondary cell having a volume of 16 cm³ (thickness: 0.44 cm, width: 8 cm, and height: 10 cm) was fabricated by the same procedure as in Example 5, except that an amount of the additive of Chemical Formula 1a was changed from 2 wt % to 4 wt %.

### Example 13

A rectangular lithium secondary cell having a volume of 16 cm³ (thickness: 0.44 cm, width: 8 cm, and height: 10 cm) was fabricated by the same procedure as in Example 5, except that an amount of the additive of Chemical Formula 1a was changed from 2 wt % to 5 wt %.

### Example 14

A rectangular lithium secondary cell having a volume of 16 cm³ (thickness: 0.44 cm, width: 8 cm, and height: 10 cm) was fabricated by the same procedure as in Example 5, except that an amount of the additive of Chemical Formula 1a was changed from 2 wt % to 10 wt %.

Overcharge Test

The lithium secondary cells according to Examples 8 to 14 and Comparative Examples 1 to 10 were discharged at 0.2 C and 2.5 V, and charged to 2 C, 12 V to confirm voltage, current, temperature and appearance of the cells. The results are shown in Table 3 as thermal stability depended on the following standard. Furthermore, the amounts of the cycle-life improvement additive of the electrolyte and the additive and the battery volume are also shown in Table 3.

In addition, for comparing, the results according to Example 5 and Comparative Example 13 are also shown in Table 3.

In Table 3, LX (X=0 to 5) indicates battery safety, and as X is smaller, a battery cell is safer.

L0: no change
L1: leakage
L2: smoke
L4: exothermic at 200° C. or more
L5: explosion

| | Amount of | | | |
|---|---|---|---|---|
| | fluoroethylene | Amount | | |
| | carbonate as cycle-life | of | Cell | |
| | improvement additive | additive | volume | Safety |
| | (wt %) | (wt %) | (cm³) | evaluation |
| Comparative | 15 | 0 | 16 | L5 |
| Example 13 | | | | |
| Example 8 | 15 | 0.1 | 16 | L1 |
| Example 9 | 15 | 0.5 | 16 | L1 |
| Example 10 | 15 | 1 | 16 | L1 |
| Example 5 | 15 | 2 | 16 | L1 |
| Example 11 | 15 | 3 | 16 | L0 |
| Example 12 | 15 | 4 | 16 | L0 |
| Example 13 | 15 | 5 | 16 | L0 |
| Example 14 | 15 | 10 | 16 | L0 |

As shown in Table 3, the lithium secondary cells according to Examples 5, and 8 to 14 using the electrolyte without the additive of Chemical Formula 1a at an amount of 0.1 wt % to 10 wt % and having a volume of 16 cm³ exhibited L0 or L1 as the overcharging result which indicated very improved safety.

Meanwhile, Comparative Example 13 in which lithium secondary cell was fabricated by using the electrolyte without the additive of Chemical Formula 1a to have a volume of 16 cm³, exhibited L5 as the result which indicated occurrence of explosion and very poor safety.

From these results, it can be clearly shown that the effects for improving safety may be obtained by using of additive of Chemical Formula 1a.

### Comparison of Amount of Fluoroethylene Carbonate

### Example 15

1.15 M LiPF₆ was added to a mixed solvent of ethylene carbonate, ethyl methyl carbonate and dimethyl carbonate (2:1:7 volume ratio), and 2 wt % of an additive of Chemical Formula 1a was added to 100 wt % of the resulting mixture to prepare an electrolyte for a lithium secondary cell.

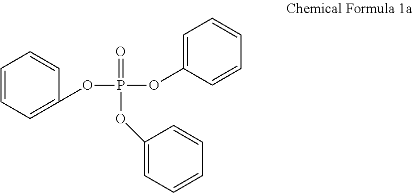 [SMILES: O=P(Oc1ccccc1)(Oc1ccccc1)Oc1ccccc1]

96 wt % of a LiNi_{0.88}Co_{0.105}Al_{0.015}O₂ positive active material, 2 wt % of a ketjen black conductive material and 2 wt % of a polyvinylidene fluoride binder were mixed in an N-methylpyrrolidone solvent to prepare a cathode active material slurry. The cathode active material slurry was coated on an aluminum foil, dried and compressed to prepare a cathode.

A mixture of graphite and a Si—C composite at an 89:11 weight ratio as an anode active material, styrene-butadiene rubber as a binder and carboxylmethyl cellulose were mixed at a weight ratio of 98:1:1 and dispersed in distilled water to prepare an anode active material slurry.

The Si—C composite had a core including artificial graphite and silicon particles, and coal pitch coated on the core, and herein, the amount of silicon was 3 wt % based on the total weight of the Si-carbon composite.

The anode active material slurry was coated on a copper foil, dried, and compressed to produce an anode.

Using the electrolyte, the cathode, and the anode, a cylindrical lithium secondary cell having a volume of 16 cm³ (diameter: 1.8 cm and height: 6.5 cm) was fabricated according to the general procedure.

### Comparative Example 20

1.15 M LiPF₆ was added to a mixed solvent of ethylene carbonate, ethyl methyl carbonate and dimethyl carbonate (2:1:7 volume ratio) to prepare an electrolyte for a lithium secondary cell.

Using the electrolyte and the cathode and the anode of Example 15, a cylindrical lithium secondary cell having a volume of 16 cm³ (diameter: 1.8 cm and height: 6.5 cm) was fabricated according to the general procedure.

Overcharge Test

The lithium second cells according to Example 15 and Comparative Example 20 were discharged at 0.2 C and 2.5 V, and charged to 2 C, 12 V to confirm voltage, current, temperature and appearance of the cells. The results are shown in Table 4, as the thermal safety based on the following standard. Furthermore, the amounts of the cycle-life improvement additive of the electrolyte and the additive and the battery volume are also shown in Table 4.

Furthermore, for comparing, the results of Example 50 are also shown in Table 4.

In Table 4, LX (X=0 to 5) indicates battery safety, and as X is smaller, a battery cell is safer.

TABLE 4
L0: no change
L1: leakage
L2: smoke
L4: exothermic at 200° C. or more
L5: explosion

| | Amount of | | | |
|---|---|---|---|---|
| | fluoroethylene | Amount | | |
| | carbonate as cycle-life | of | Cell | |
| | improvement additive | additive | volume | Safety |
| | (wt %) | (wt %) | (cm³) | evaluation |
| Comparative | 0 | 0 | 16 | L5 |
| Example 20 | | | | |
| Example 15 | 0 | 2 | 16 | L1 |
| Example 5 | 15 | 2 | 16 | L1 |

As shown in Table 4, it can be known that Examples 15 and 5 in which the electrolyte with the additive of Chemical Formula 1a or with the additive together with fluoroethylene carbonate exhibited Li as the overcharging result and thus, it exhibited very improved safety.

Whereas, Comparative Example 20 using the electrolyte without both additive of Chemical Formula 1a and fluoroethylene carbonate had L5 as the overcharging evaluation result, and thus it exhibited extremely deteriorated safety.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. A lithium secondary battery, comprising:
a cathode comprising a cathode active material;
an anode comprising an anode active material; and
an electrolyte comprising a non-aqueous organic solvent, a lithium salt and an additive represented by Chemical Formula 1,
wherein the lithium secondary battery has a volume of 16 cm³ to 84 cm³. 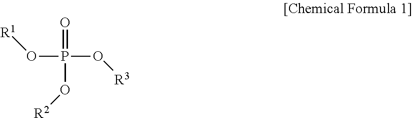
(in chemical formula 1,
R¹ to R³ are each independently a substituted or unsubstituted alkyl group, a substituted or unsubstituted alkenyl group, or a substituted or unsubstituted aryl group).

2. The lithium secondary battery of claim 1, wherein the R¹ to R³ are each independently a substituted or unsubstituted aryl group.

3. The lithium secondary battery of claim 1, wherein an amount of the additive is 0.1 wt % to 10 wt % based on the total weight of the electrolyte.

4. The lithium secondary battery of claim 1, wherein the additive represented by Chemical Formula 1 is triphenyl phosphate (TPP), triethylphosphate, diethyl allyl phosphate, 2-ethylhexyl diphenyl phosphate or a combination thereof.

5. The lithium secondary battery of claim 1, wherein the additive represented by Chemical Formula 1 is triphenyl phosphate.

6. The lithium secondary battery of claim 1, wherein the electrolyte further comprises an additive for improving cycle-life represented by Chemical Formula 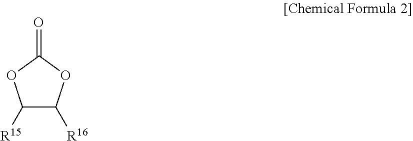
(in chemical formula 2, R¹⁵ and R¹⁶ are each independently selected from hydrogen, a halogen, a cyano group (CN), a nitro group (NO₂), or a fluorinated C1 to C5 alkyl group, provided that at least one of the R¹⁵ and R¹⁶ is selected from a halogen, a cyano group (CN), a nitro group (NO₂), or a fluorinated C1 to C5 alkyl group, and R¹⁵ and R¹⁶ are not simultaneously hydrogen.)

7. The lithium secondary battery of claim 6, wherein an amount of the additive for improving cycle-life is 10 wt % to 20 wt % based on the total, 100 wt % of the electrolyte.

8. The lithium secondary battery of claim 1, wherein the lithium secondary battery is a cylindrical battery having a diameter of 1.8 cm to 3.2 cm and a height of 6.5 cm to 10.5 cm, or a rectangular battery of a thickness of 0.54 cm to 0.7 cm, a width of 4.4 cm to 7.4 cm, and a height of 5.1 cm to 10 cm.

9. The lithium secondary battery of claim 1, wherein the non-aqueous organic solvent comprises 50 volume % to 95 volume % of linear carbonate, linear ester or a combination thereof, and 5 volume % to 50 volume % of cyclic carbonate.

10. The lithium secondary battery of claim 1, wherein the positive active material is at least one lithium composite oxide represented by Chemical Formula 3.
LiₐM¹_{1-y1-z1}M²_{y1}M³_{z1}O₂ [Chemical Formula 3]
(in chemical formula 3,
0.9≤a≤1.8, 0≤y1≤1, 0≤z1≤1, 0≤y1+z1<1, M¹, M² and M³ are each independently one selected from a metal of Ni, Co, Mn, Al, Sr, Mg or La, etc., or a combination thereof)

11. The lithium secondary battery of claim 1, wherein the negative active material comprises a Si-composite comprising a Si-based active material and a carbon-based active material.

12. The lithium secondary battery of claim 11, wherein the negative active material further comprises crystalline carbon.
